(19) United States
(12) Patent Application Publication
(10) Pub. No.: US 2015/0039488 A1
(43) Pub. Date: Feb. 5, 2015

(54) System and Method to Provide Informational Depth via a Gradient Indicator

(71) Applicant: Trading Technologies International, Inc., Chicago, IL (US)

(72) Inventor: Patrick J. Rooney, St. Charles, IL (US)

(73) Assignee: Trading Technologies International, Inc., Chicago, IL (US)

(21) Appl. No.: 14/142,847

(22) Filed: Dec. 29, 2013

Related U.S. Application Data
(60) Provisional application No. 61/861,890, filed on Aug. 2, 2013.

(51) Int. Cl. G06Q 40/04

(52) U.S. Cl. CPC G06Q 40/04
USPC 705/37

(57) ABSTRACT

Example methods, systems, and computer-readable media are disclosed and described to display trading information via a trading interface. An example method to display trading parameters via a graphical trading interface includes defining a first user interface element to be displayed in the graphical trading interface at a computing device. The example method includes identifying a first trading parameter to be displayed via the first user interface element. The example method includes determining a second trading parameter to be displayed with the first trading parameter via the first user interface element, the second trading parameter to be display concurrently with but discernible from the first trading parameter via the first user interface element. The example method includes displaying data relating to the first trading parameter and data relating to the second trading parameter via the first user interface element.

### CROSS-REFERENCE TO RELATED APPLICATIONS

This patent claims the benefit of U.S. Provisional Application Ser. No. 61/861,890, entitled “System and Method to Provide Informational Depth Via a Gradient Indicator,” which was filed on Aug. 2, 2013, and is hereby incorporated herein by reference in its entirety for all purposes.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

Traders and other market participants typically monitor and/or interact with multiple markets on one or more electronic exchanges, the large volume of information generated by and changed with the electronic exchanges make space a premium for traders interested in a comprehensive display of market information on a trading device.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an example display to provide informational depth via a gradient indicator.

FIG. 5 illustrates another example display to provide informational depth via a gradient indicator.

FIG. 6 illustrates another example display to provide informational depth via a gradient indicator.

FIG. 7 illustrates an example gradient indicator integrated with a trading display.

FIG. 8 illustrates a flow diagram for an example method to generate a multi-layered user interface element.

FIG. 9 illustrates a flow diagram for an example method to display trading data via a user interface.

FIG. 10 illustrates a trading interface display generator to compose one or more multi-layer user interface elements in a trading interface.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The embodiments and subject matter disclosed herein generally relate to organization and display of information. The disclosed examples highlight and present numerous systems, methods, and apparatus including elements configured to provide informational depth via a gradient and/or other secondary indicator.

For example, a user interface may include one or more user interface elements (e.g., cells) that convey more than one data item. That is, a single user interface element can include a trading parameter value as well as a gradient indicator and/or other associated information relating to the trading parameter value, for example. Historical, context, trend, and/or other market information can be conveyed in addition to a parameter value (e.g., last traded price, last traded quantity, high, low, etc.) without occupying additional display real estate in a graphical trading interface (e.g., particularly a graphical trading user interface executing on a mobile device such as a tablet computer, smart phone, etc., with more limited screen size than a traditional desktop or laptop computer display). In certain examples, a plurality (e.g., “n”) levels of data can be conveyed via a single cell or other display element in a graphical user interface.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Example methods, systems, and computer-readable media are disclosed and described to provide a multi-level or multi-layered display of trading information. An example method to display trading parameters via a graphical trading interface includes defining a first user interface element to be displayed in the graphical trading interface at a computing device. The example method includes identifying, at the computing device, a first trading parameter to be displayed via the first user interface element. The example method includes determining, at the computing device, a second trading parameter to be displayed with the first trading parameter via the first user interface element, the second trading parameter to be display concurrently with but discernible from the first trading parameter via the first user interface element. The example method includes displaying, at the computing device, data relating to the first trading parameter and data relating to the second trading parameter via the first user interface element.

In certain examples, data relating to the first trading parameter is displayed as alphanumeric data, and data relating to the second trading parameter is displayed via at least one of color, shading, and texture. In certain examples, the first user interface element displays data relating to a value for the first trading parameter, and the method includes displaying, at the computing device, a second user interface element including a label for the first trading parameter. In certain examples, the first trading parameter includes at least one of a last traded price, a last traded quantity, a total traded quantity, a total traded quantity at price, a volume at price, a price at open, and a price at close for a tradeable object, and the second trading parameter includes at least one of a volatility, a trend, a relative value, a range, and an alert related to the first trading parameter.

In certain examples, the method includes displaying a third trading parameter via the first user interface element. In certain examples, the method includes displaying, via the first user interface element, a level line representing a historical indication with respect to the first trading parameter.

An example system includes a computing device configured to provide a graphical trading interface. The example computing device is to define a first user interface element to be displayed via the graphical trading interface. The example computing device is to identify a first trading parameter to be displayed via the first user interface element. The example computing device is to determine a second trading parameter to be displayed with the first trading parameter via the first user interface element, the second trading parameter to be display concurrently with but discernible from the first trading parameter via the first user interface element. The example computing device is to display data relating to the first trading parameter and data relating to the second trading parameter via the first user interface element.

In certain examples, data relating to the first trading parameter is displayed as alphanumeric data and wherein data relating to the second trading parameter is displayed via at least one of color, shading, and texture. In certain examples, the first user interface element is to display data relating to a value for the first trading parameter, and the computing device is further to display a second user interface element including a label for the first trading parameter. In certain examples, the first trading parameter includes at least one of a last traded price, a last traded quantity, a total traded quantity, a total traded quantity at price, a volume at price, a price at open, and a price at close for a tradeable object, and the second trading parameter includes at least one of a volatility, a trend, a relative value, a range, and an alert related to the first trading parameter.

In certain examples, the computing device is to display a third trading parameter via the first user interface element. In certain examples, the computing device is to display, via the first user interface element, a level line representing a historical indication with respect to the first trading parameter.

An example tangible computer-readable storage medium includes instructions that, when executed, cause a computing device to at least define a first user interface element to be displayed via a graphical trading interface. The example computing device is to identify a first trading parameter to be displayed via the first user interface element. The example computing device is to determine a second trading parameter to be displayed with the first trading parameter via the first user interface element, the second trading parameter to be display concurrently with but discernible from the first trading parameter via the first user interface element. The example computing device is to display data relating to the first trading parameter and data relating to the second trading parameter via the first user interface element.

In certain examples, data relating to the first trading parameter is displayed as alphanumeric data and wherein data relating to the second trading parameter is displayed via at least one of color, shading, and texture. In certain examples, the first user interface element is to display data relating to a value for the first trading parameter, and the computing device is further to display a second user interface element including a label for the first trading parameter. In certain examples, the first trading parameter includes at least one of a last traded price, a last traded quantity, a total traded quantity, a total traded quantity at price, a volume at price, a price at open, and a price at close for a tradeable object, and the second trading parameter includes at least one of a volatility, a trend, a relative value, a range, and an alert related to the first trading parameter.

In certain examples, the computing device is to display a third trading parameter via the first user interface element. In certain examples, the computing device is to display, via the first user interface element, a level line representing a historical indication with respect to the first trading parameter.

### II. Example Electronic Trading System

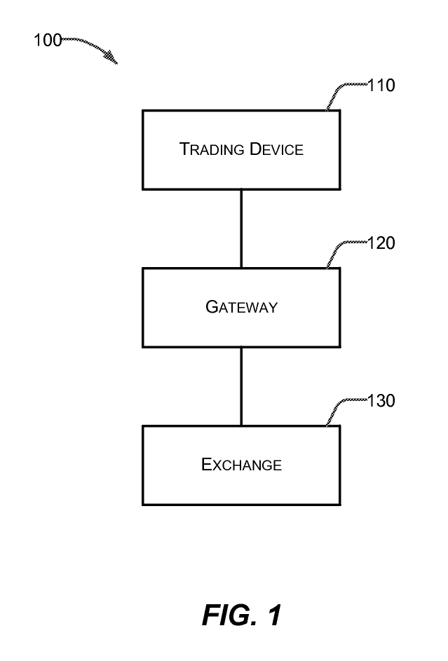

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradeable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order (also referred to as a trade action) may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof. One or more trade orders can be organized according to a trading strategy, for example.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment that does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

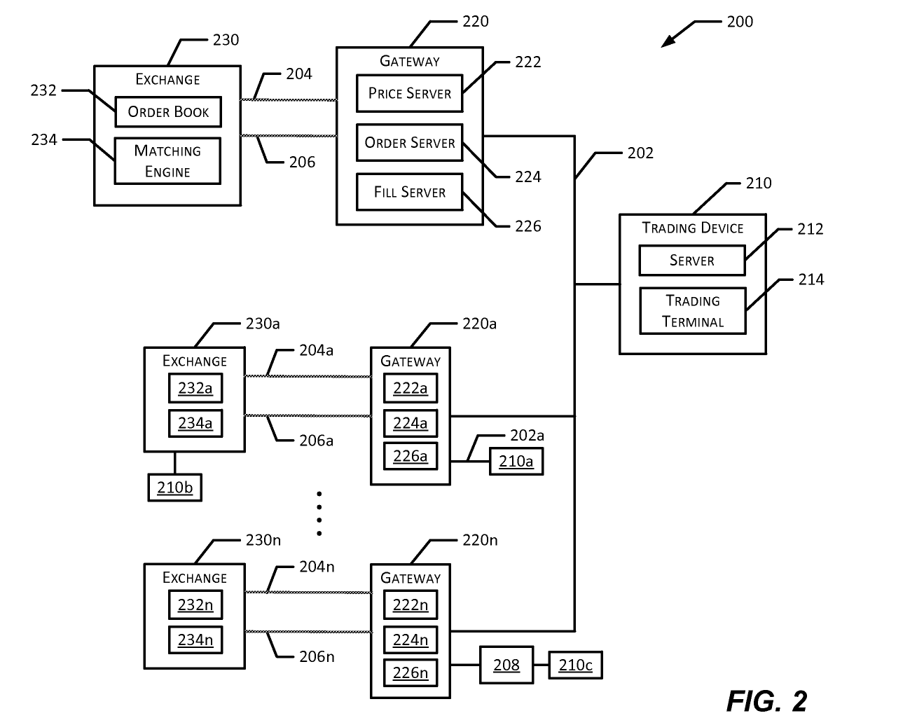

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

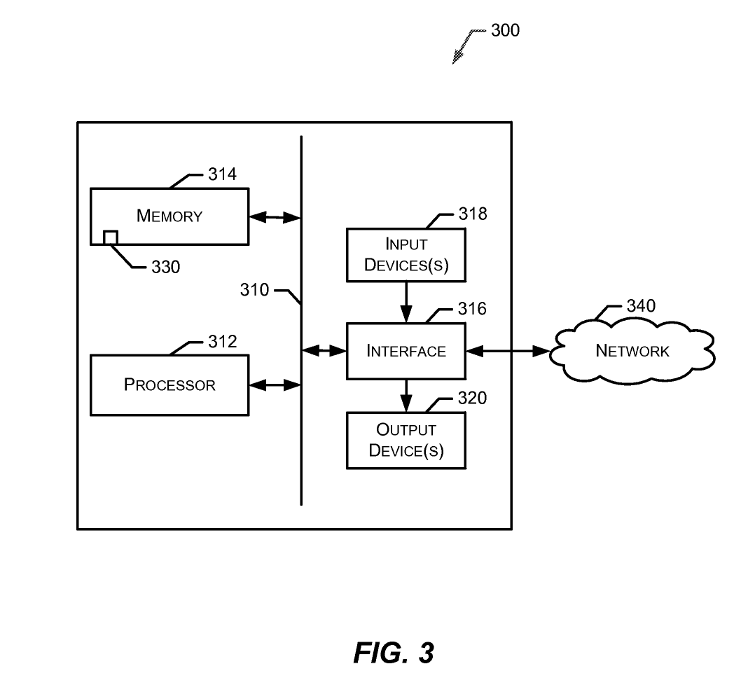

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors that are communicatively coupled to the communication network 310.

The processor 312 may be operable to execute logic and other computer readable instructions encoded in one or more tangible media, such as the memory 314. As used herein, logic encoded in one or more tangible media includes instructions that may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions that are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. INFORMATIONAL DEPTH VIA A GRADIENT INDICATOR

Disclosed embodiments generally relate to communicating information to a user, and more particularly, to displaying multiple layers of market information via a single display element. Multiple layers may be provided for convenience, for space-savings, etc. Multiple layers of information may compound a user's at-a-glance understanding of market conditions, market options, and the like. Using multiple levels or layers, a plurality of pieces of information can be combined, overlaid, and/or otherwise display together, for example.

Certain examples provide a multi-layered display of information arranged according to user interface elements forming a user interface displayed via a trading application executing on a trading device and/or other computing device. For example, an alphanumeric value for a trading parameter can be displayed within a same user interface element as one or more additional aspects of that trading parameter (e.g., volatility, trend, relative value, range, alert, user instruction, etc.). Thus, on a device with limited display space available, multiple values can be provided within a single user interface element, for example. Further, even if display real estate limitations are not an issue, information can be conveyed to a user quickly, easily, and compactly via a single user interface element, for example.

In one embodiment, a computer system having an input device, a video display, a network interface, and at least a trading interface application executes an example method for user interface display. The method includes outputting a user interface element on the video display, the user interface element associated with a trading parameter derived from market data; displaying the trading parameter on the video display, wherein the trading parameter is configured in a numerical format as a portion of the user interface element; and displaying a second trading parameter as a function of a format parameter associated with the user interface element, wherein the second trading parameter is related to (although perhaps independent from) the first trading parameter. Interaction with the user interface can then be facilitated.

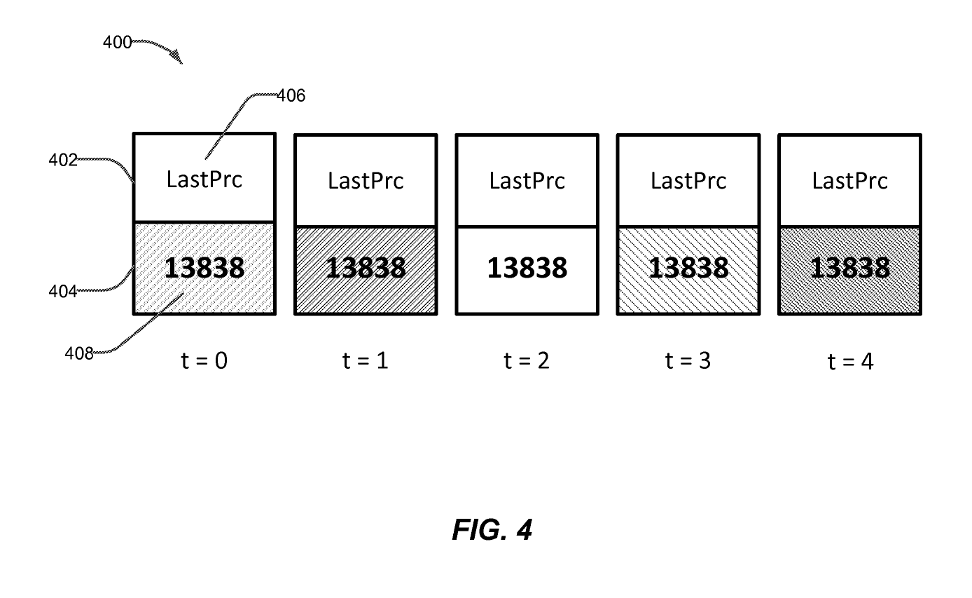

FIG. 4 illustrates an example of a trading application configured to provide multiple layers of information by incorporating a gradient indicator (e.g., a color, contrast, range of color/contrast, shading, pattern, line, etc.) into one or more user interface elements. The example trading application is configured to generate and display a user interface element 400. The example user interface element 400 shown in FIG. 4 is configured to display the last traded price (LTP or LastPrc). In other examples, the user interface element 400 may display alternate and/or additional information such as last traded quantity (LTQ), total traded quantity (TTQ), total traded quantity at price (TTQAP), volume at price (VAP), price at open, price at close, and/or any other desired information.

The user interface element 400 shown in FIG. 4 includes a first cell 402 and a second cell 404. The bottom edge of the first cell 402, as viewed in the plane of the page, is arranged above and adjacent to the top edge of the second cell 404. Arranged this way, the user interface element 400 shown in the example of FIG. 4 defines a vertically aligned interface element. In the present example, the first cell 402 is identified with a cell label 406 and the second cell 404 displays a cell value 408 received or calculated at the trading device 110 (or 210).

The example shown in FIG. 4 depicts the user interface element 400 displaying LTP (identified as LastPrc) at five (5) points in time individually identified as times t=0 to time t=4. The illustrated user interface element 400 is configured to provide multiple types or layers of information to a user. For example, the user interface element 400 incorporates a gradient change in color associated with a background of the second cell 404 in order to reflect the position of the cell value 408 relative to a range of possible values. For example, a trader or other user may wish to see where the current price is relative to the high/low of the day or relative to any other defined period of time. By displaying both the current value (cell value 408) and adjusting the background color of the second cell 404, the user interface element 400 can provide additional information (e.g., informational depth) to the user. In this way, users may replace one or more dedicated columns or dedicated elements configured to display, for example, the high and low price of the day with one or more versions of the disclosed user interface element 400 configured to display multiple layers of information within the same element or space. By allowing multiple pieces of related (yet often independent) information to be displayed in a single user interface element, users may efficiently utilize the limited display space available on most trading devices 110 (210).

In certain examples, both label and parameter information (value along with an additional gradient indicator) can be displayed via a single user interface element 402 or 404. That is, both a cell label 406 and a cell value 408 can be combined in a single cell 402 or 404, rather than separated into two cells 402 and 404. A further gradient indicator associated with the cell label 406 and/or cell value 408 can also be displayed (e.g., a level line and/or other gradient indicator).

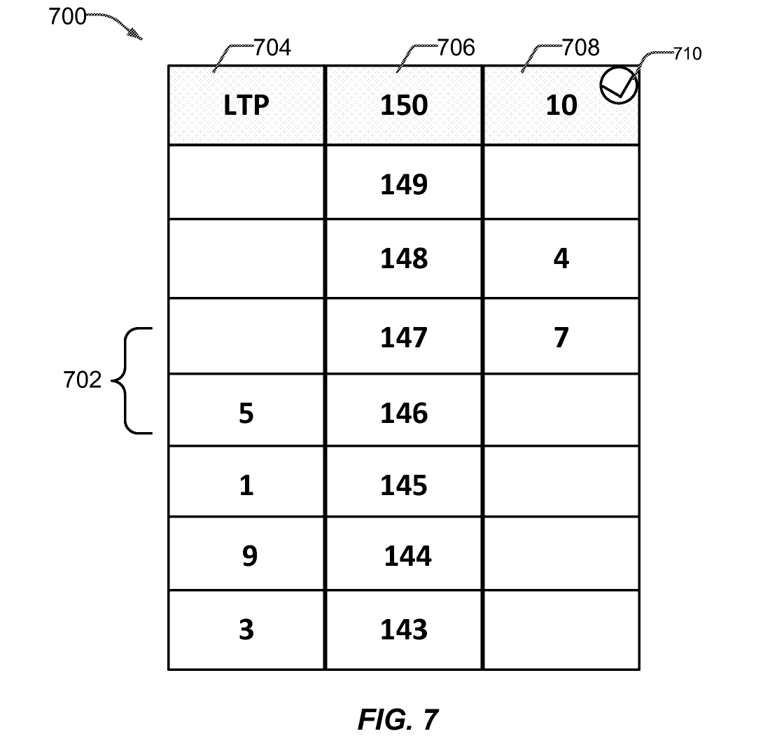

In operation, the user interface element 400 may be configured to display multiple pieces of related information. In addition to displaying LTP as a part of the cell value 408, the background color of the second cell 404 may be adjusted to reflect the relative position of the current LTP to a range of LTP values. The range, in one example, may reflect that the LTP has varied between a low value of 10 and high value of 20. In this instance, if the displayed LTP equals 11, then the background color can be adjusted to indicate that the current LTP is near the low value of the day. As shown in FIG. 4, the range may be defined such that a low value is associated with a first color and/or pattern/shading (e.g., the color yellow and/or a certain pattern or shading, etc.) while the high value is associated with a second color and/or pattern/shading (e.g., the color green and/or a certain pattern or shading, etc.). The intensity of the colors and/or spacing of lines in a pattern, for example, may, in turn, indicate how close the current LTP is to either the high or low LTP values established by the range. For example, at time t=0, the background color of the second cell 404 is a dark green (represented in the figure as a first pattern) indicating that the cell value 408 is near to the high value. As the cell value 408 decreases, the background color of the second cell 404 changes to a lighter green (see time t=1, shown in the example of the figure as a second pattern) to indicate that the current LTP is greater than the midpoint of the defined range. If the current LTP is substantially equal to the midpoint of the defined range, then the background color of the second cell 404 may be set to a white, clear or some other “neutral” color (shown in the example of the figure as a third pattern). Similarly, as the current LTP falls below the midpoint of the range, the background color of the second cell 404 changes from a light yellow (see time t=3, shown in the example of the figure as a fourth pattern) to a darker, more intense, yellow (see time t=4, shown in the example of the figure as a fifth pattern) to indicate that the cell value 408 is near or equal to the low value of the defined range. The gradient coloration can be used with any portion of the user interface element 400 to note a relative range. For example, the cell label 406 identifying the name of the displayed data can be colored, shaded, patterned, etc. In other embodiments, an entire row of data can be colored, shaded, patterned, etc. (see, e.g., FIG. 7).

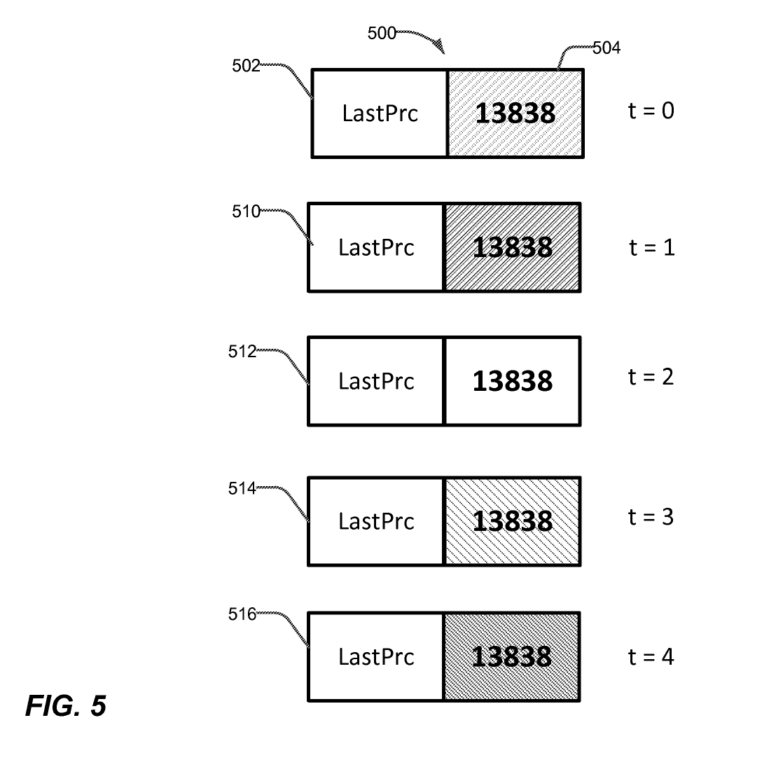

FIG. 5 illustrates another embodiment of a user interface element 500 arranged as a substantially horizontally aligned interface element. For example, the right edge of the first cell 502, as viewed in the plane of the page, is arranged to left of and adjacent to the left edge of the second cell 504. In this configuration, multiple instances of the user interface element 500, individually identified by the reference numerals 510 to 516 may be stacked vertically to form an informational block or widget. For example, one informational block or widget may include and display values for LTP, LTQ, VAP, TTQ and TTQAP along with additional information regarding the value (e.g., a color, pattern, shading, and/or other differentiation indicating relative value, range, volatility, threshold, etc.).

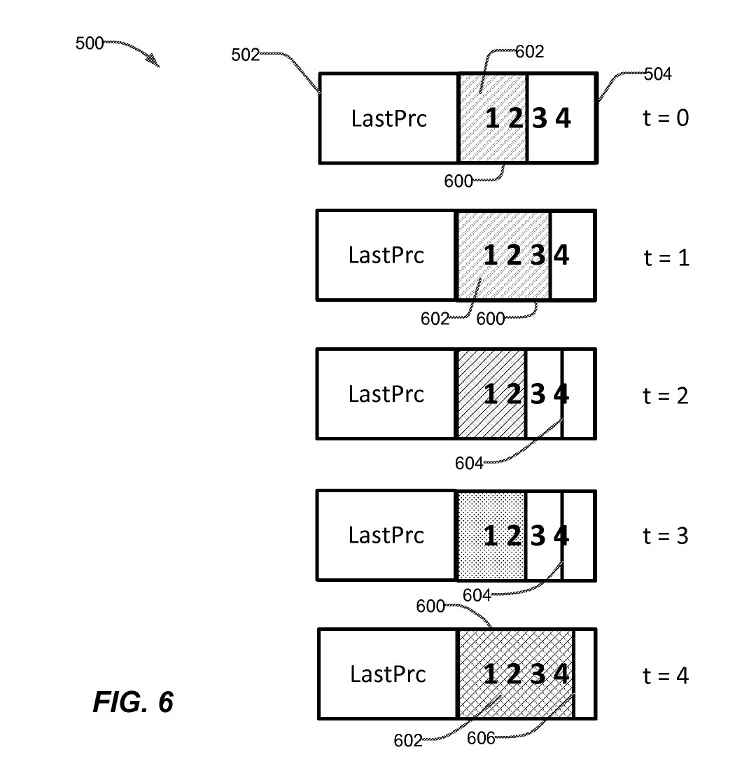

FIG. 6 illustrates another embodiment of the example user interface element 500 in which the background of the second cell 504 is configured to provide multiple layers of information to the user. For example, the background of the second cell 504 may behave as a bar graph 600 and change lengths (relative to the background color, pattern, and/or shading, etc., of the window or screen) in accordance with a unique market parameter such as trade volume. As with the embodiment shown in FIG. 4, a color and/or pattern 602 of the second cell's 504 background may be adjusted to reflect the relative position of the displayed variable to a range of values. Thus, as shown in FIG. 6, at time t=0, the color and/or pattern 602 of the background of the second cell 504 may indicate that the displayed cell value 408 is near or nearing a high value of the defined range. Similarly, at time t=1, the color and/or pattern 602 of the background of the second cell 504 may indicate that the displayed cell value 408 has remained substantially unchanged while the trade volume has increased.

In certain examples, as illustrated in FIG. 6, a level line 604 and/or other similar indicator shows a representation of a historical value for the parameter associated with the cell 504 (e.g., a midpoint, a range, a previous high value, previous low value, historical average, etc.). For example, at time t=2 of the example of FIG. 6, the trade volume has decreased from the previous high as indicated by the level line 604 while the displayed cell value 408 nears a midpoint of the defined range as indicated by the color/pattern/shading/etc. 602. As shown between times t=2 and time t=3, display properties of the level line 604 such as color, pattern, thickness, etc., may be varied and adjusted to highlight the passage of time and/or other change or event occurrence. For example, the level line 604 may be adjusted to fade away over time or replaced as a new level line (e.g., the right edge 606 of the bar graph 600 as shown at time t=4) is established.

Thus, a combination of gradient, level line, label, and alphanumeric data can be used to convey a current value as well as a historical and/or peer comparison. Variation can be shown between adjacent values and/or cells and/or within a same cell (e.g., to show a curve between values or within the same value). Via one or more combinations of indicia, N layers of information can be conveyed through a small area of display screen real estate. A level line, color/pattern gradient indication, volume bar, relative indicator, etc., can be used to convey information such as relative price, change in price, movement with respect to a midpoint, movement with respect to a range over a time interval (e.g., five minutes, ten minutes, one month, etc.), and so on. In certain examples, a periodic refresh and/or reset can occur based on a local system clock, server clock, atomic clock, etc. A multi-layered combination of information can be retrieved together, independently, etc.

FIG. 7 illustrates a simple trading ladder 700 configured to display a layer of market information along one row of the ladder. For example, the selected row may be positioned away from the inside market 702 and include display elements 704 to 708. Each of the display elements may, in turn, be configured to represent LTP (as indicated in the upper left corner of element 704) for the respective columns of the ladder. In certain examples, the element 706 can represent other information or parameters. A check graphic 710 (e.g., an icon or other representation of a check mark, etc.) or another such indicator may be overlaid upon, for example, the element 708. The check graphic 710 may serve as a visual reminder that the row is configured to display more than one layer of information and market data. For example, the present disclosure is related to U.S. Pat. No. 6,772,132, entitled “Click Based Trading with Intuitive Grid Display of Market Depth,” filed on Jun. 9, 2000, the content of which is incorporated herein by reference in its entirety. In certain examples, the check graphic 710 may be used as a toggle or hot key for user selection to trigger a gradient indicator mode, retrieve additional information, switch to a different view, etc.

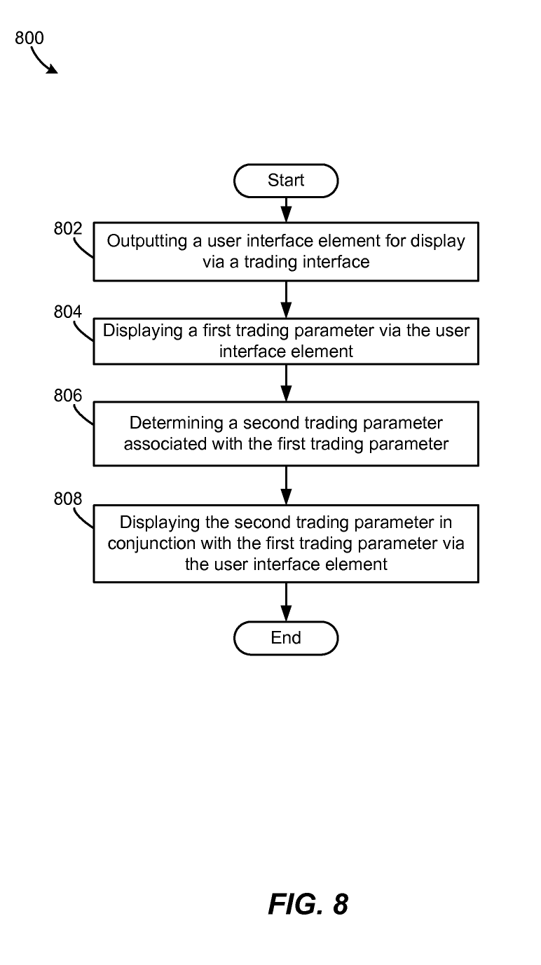

FIG. 8 illustrates a flow diagram 800 for an example method to generate a multi-layered user interface element. For example, multiple pieces of related information can be provided (e.g., displayed) via a single user interface element (and/or pair of user interface elements). Thus, two user interface elements can provide an item label in one element and associated information (e.g., value, relative value, trend, range, user risk, etc.) in another associated element, or all such information can be provided in a single user element, for example.

At block 802, a user interface element is output for display via a user interface. For example, a user interface element associated with one or more trading parameters (e.g., LTP, LTQ, TTQAP, VAP, etc.) is generated and output for display via a trading interface on a computing device. The user interface element can be arranged to convey one or multiple pieces of information regarding the one or more trading parameters, for example.

At block 804, a first trading parameter is displayed via the user interface element. For example, a last traded price (LTP or “LastPrc”) value, which is associated with the user interface element (e.g., a cell or block in a trading interface labeled “LASTPRC”, etc.) is shown via the user interface element. That is, if the example user interface element shows the label “LASTPRC”, the first trading parameter value of “1234”, indicative of the Last Traded Price for that contract, is displayed via the user interface element.

At block 806, a second trading parameter is identified in association with the first trading parameter. The second trading parameter can be independent from and/or related to the first trading parameter. For example, a volatility, change in price over a time interval, trend, volume, other price and/or quantity information, etc., can be identified as associated with the first trading parameter (e.g., last traded price in this example, etc.). The second trading parameter can provide an additional dimension, further insight, and/or other information associated with the first trading parameter, for example. That is, a shaded gradient indicator associated with a last traded price can indicate how the displayed last traded price compares to a historical average, recent trend, recent range of last traded prices, etc., for example.

At block 808, the second trading parameter is displayed in conjunction with the first trading parameter via the user interface element. For example, a shading, pattern, color, line, and/or other indicator is displayed in a same cell or other user interface element as the alphanumeric value shown as the first trading parameter. For example, a trend associated with a last traded price can be indicated through a visual pattern displayed in conjunction with a parameter value corresponding to the last traded price of the selected contract (e.g., hashing of lines overlaid and/or displayed behind the last traded price value).

Thus, certain examples provide a multi-layered (e.g., 2-level, 3-level, n-level, etc.) display of information arranged according to one or more user interface elements forming a user interface displayed via a trading application executing on a trading device and/or other computing device. For example, an alphanumeric value for a trading parameter (e.g., opening price, closing price, high price, low price, etc.) can be displayed via a same user interface element as one or more additional aspects of that trading parameter (e.g., volatility, trend, relative value, range, alert, user instruction, etc.). On a device with limited display space available, multiple values can be provided within a single user interface element, for example. Further, even if display real estate limitations are not an issue, information can be conveyed to a user quickly, easily, and compactly via a single user interface element, for example.

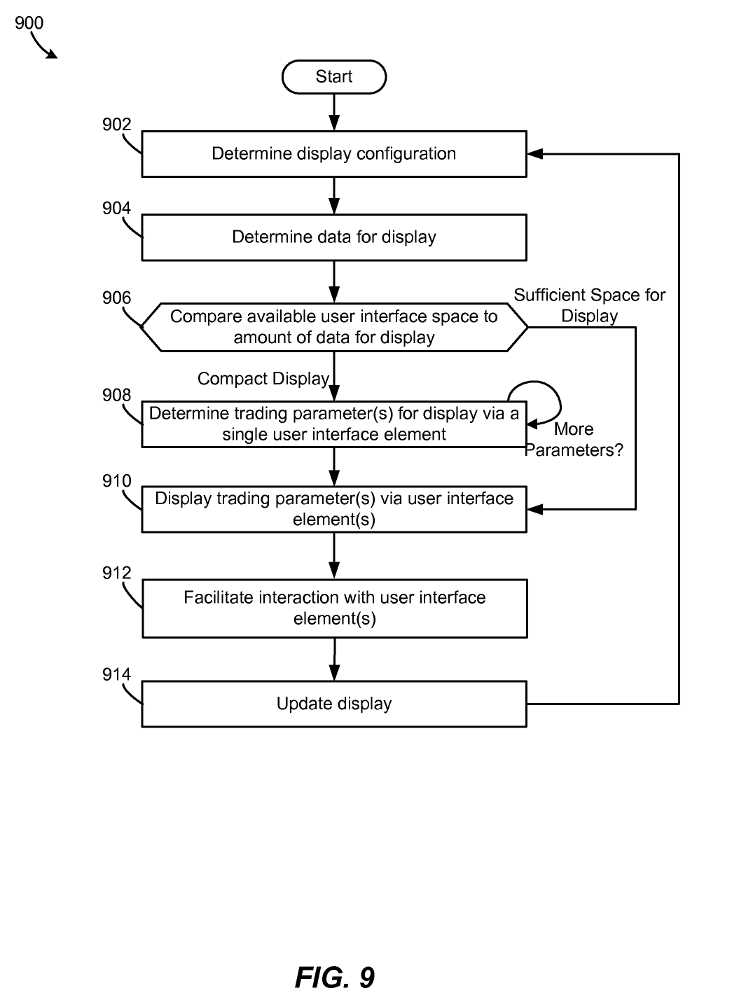

FIG. 9 illustrates a flow diagram 900 for an example method to display trading data via a user interface. First, at block 902, a display configuration for a target trading device is determined. For example, the trading device (e.g., a desktop computer, laptop computer, tablet computer, smartphone, etc.) is identified and its associated display area is determined. A larger trading device, such as a desktop computer, may have a greater display area than a smaller device, such as a smartphone. A desktop computer may have multiple monitors, for example. Additionally, the trading device may be displaying other information which reduces an available area of screen real estate for display of trading data at the target trading device.

At block 904, data to be displayed is determined. For example, an amount and type of data to be displayed is determined, such as one or more information feeds including one or more trading parameters for one or more contracts, etc. That is, one user may be tracking one trading information feed while another user may be monitoring three information feeds. Each of these users' configurations involves a different amount of data to be displayed (one feed versus three feeds, for example).

At block 906, available display space for a trading user interface is compared to the amount of data available for display. For example, if there is sufficient space available to display the data in a “normal” trading interface without layering or consolidation, then “normal” display configuration occurs. For example, one user may be viewing data via a laptop computer while another user may be viewing data via a tablet computer, each device having different space available for data display. If a compact or “smaller than normal” display is available (e.g., smartphone, tablet computer, laptop or desktop computer having multiple application/interface windows open at once, etc.) or compact display of the data is desired (e.g., according to user configuration or selection), then, at block 908, one or more trading parameter(s) are identified from the data that can be displayed via a single user interface element.

For example, a first trading parameter is identified from the provided information feed(s). For example, a last traded price (LTP or “LastPrc”) value, which is associated with the user interface element (e.g., a cell or block in a trading interface labeled “LASTPRC”, etc.) is shown via the user interface element. That is, if the example user interface element shows the label “LASTPRC”, the first trading parameter value of “1234”, indicative of the Last Traded Price for that contract, is displayed via the user interface element.

Additionally, a second trading parameter is identified from the provided information feed(s). The second trading parameter may or may not be associated with the first trading parameter. For example, a volatility, change in price over a time interval, trend, volume, other price and/or quantity information, etc., can be identified as associated with the first trading parameter (e.g., last traded price in this example, etc.). However, the second trading parameter is selected to provide an additional dimension, further insight, and/or other information associated with the first trading parameter, for example. That is, a shaded gradient indicator associated with a last traded price can indicate how the displayed last traded price compares to a historical average, recent trend, recent range of last traded prices, etc., for example.

At block 910, trading parameter(s) are displayed via user interface element(s). For example, the second trading parameter discussed above is displayed in conjunction with the first trading parameter via a user interface element. For example, a shading, pattern, color, line, and/or other indicator is displayed in a same cell or other user interface element as the numerical value shown as the first trading parameter (e.g., last traded price, etc.).

At block 912, interaction with user interface element(s) is facilitated. For example, a trading order and/or trading strategy of one or more trade orders can be facilitated through selection of one or more user interface elements. For example, a user can select a user interface element showing a last traded price for an item in order to facilitate a trade for that item.

At block 914, the display is updated. For example, the display may be updated based on user interaction with one or more user interface elements (e.g., based on facilitation of a trade via the user interface, price and/or quantity update, trading strategy update, etc.). Alternatively or in addition, the display may be updated based on data updates provided to the user interface, for example.

Thus, certain examples disclosed and described herein provide increased use of available display area to convey one or more pieces of information. A single cell or other element in a graphical user interface can be used to display a plurality of informational aspects surrounding a trading parameter such as last traded price, last traded quantity, bid, ask, etc. Using a multi-layered display (e.g., 2-level, 3-level, n-level, etc.), not only can use of display area be improved but user attention can also remain focused on fewer graphical elements to gain the same amount of information available in a larger display area via a single-layer trading interface executing on a trading device and/or other computing device.

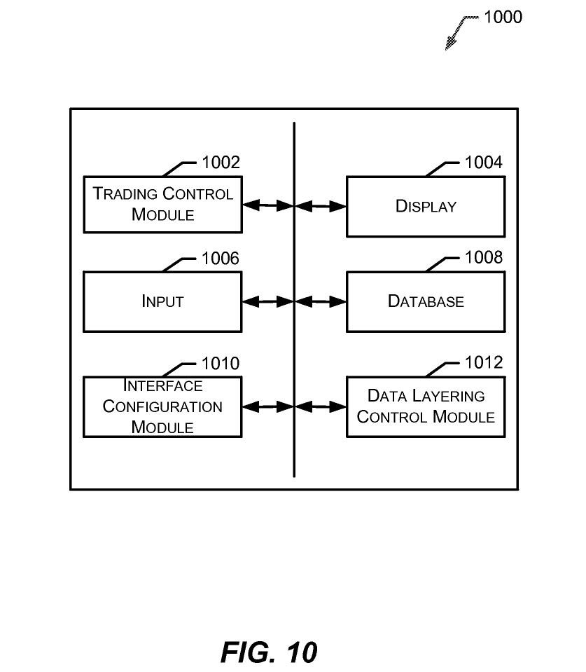

FIG. 10 illustrates an example trading interface display generator 1000 to compose one or more multi-layer user interface elements in a trading interface. The example trading interface display generator 1000 depicted in FIG. 10 includes a trading control module 1002, a display 1004, an input 1006, a database 1008, an interface configuration module 1010, and a data layering control module 1012.

As shown in the example of FIG. 10, the trading control module 1002 receives a trading data input to be output via the display 1004. Data can be stored in the database 1008, for example. The database 1008 can also store user and/or display configuration and/or preference parameters, for example. The interface configuration module 1010 processes the data for display according to such parameter(s) in accordance with information such as an amount of data to be displayed, an available display area, etc.

For example, the interface configuration module 1010 can determine a display configuration for a target trading device associated with the trading control module 1000. For example, the trading device (e.g., a desktop computer, laptop computer, tablet computer, smartphone, etc.) is identified and its associated display area is determined. A larger trading device, such as a desktop computer, may have a greater display area than a smaller device, such as a smartphone. A desktop computer may have multiple monitors, for example. Additionally, the trading device may be displaying other information which reduces an available area of screen real estate for display of trading data at the target trading device. The interface configuration module 1010 further works with the trading control module 1002 to determine an amount and type of data to be displayed, such as one or more information feeds including one or more trading parameters for one or more contracts, etc. That is, one user may be tracking one trading information feed while another user may be monitoring three information feeds. Each of these users' configurations involves a different amount of data to be displayed (one feed versus three feeds, for example).

If the interface configuration module 1010 determines that a compact or “smaller than normal” display configuration is to be implemented, then one or more trading parameter(s) are identified from the data that can be displayed via a single user interface element. For example, a first trading parameter is identified from the provided information feed(s). For example, a last traded price (LTP or “LastPrc”) value, which is associated with the user interface element (e.g., a cell or block in a trading interface labeled “LASTPRC”, etc.) is shown via the user interface element. That is, if the example user interface element shows the label “LASTPRC”, the first trading parameter value of “1234”, indicative of the Last Traded Price for that contract, is displayed via the user interface element.

Additionally, the interface configuration module 1010 identifies a second trading parameter in association with the first trading parameter. For example, a volatility, change in price over a time interval, trend, volume, other price and/or quantity information, etc., can be identified as associated with the first trading parameter (e.g., last traded price in this example, etc.). The second trading parameter can provide an additional dimension, further insight, and/or other information associated with the first trading parameter, for example. That is, a shaded gradient indicator associated with a last traded price can indicate how the displayed last traded price compares to a historical average, recent trend, recent range of last traded prices, etc., for example.

The data layering control module 1012 works with the interface configuration module 1010 to display trading parameter(s) via one or more user interface element(s) on the display 1004. For example, the second trading parameter discussed above is displayed in conjunction with the first trading parameter via a user interface element. For example, a shading, pattern, color, line, and/or other indicator is displayed in a same cell or other user interface element as the numerical value shown as the first trading parameter (e.g., last traded price, etc.).

A user can then interact with the displayed user interface via the input 1006. For example, a trading order and/or trading strategy of one or more trade orders can be facilitated through selection of one or more user interface elements. User input 1006 can be used by the trading control module 1002 to facilitate a trade and/or other update of market data, for example. Based on information from the input 1006 and/or updated data from one or more data feeds, the display 1004 can be updated. For example, the display may be updated based on user interaction with one or more user interface elements (e.g., based on facilitation of a trade via the user interface, price and/or quantity update, trading strategy update, etc.). Alternatively or in addition, the display may be updated based on data updates provided to the user interface, for example.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed.

1. A method to display trading parameters via a graphical trading interface, the method comprising:
defining a first user interface element to be displayed in the graphical trading interface at a computing device;
identifying, at the computing device, a first trading parameter to be displayed via the first user interface element;
determining, at the computing device, a second trading parameter to be displayed with the first trading parameter via the first user interface element, the second trading parameter to be display concurrently with but discernible from the first trading parameter via the first user interface element; and
displaying, at the computing device, data relating to the first trading parameter and data relating to the second trading parameter via the first user interface element.

2. The method of claim 1, wherein data relating to the first trading parameter is displayed as alphanumeric data and wherein data relating to the second trading parameter is displayed via at least one of color, shading, and texture.

3. The method of claim 1, wherein the first user interface element displays data relating to a value for the first trading parameter, and further comprising displaying, at the computing device, a second user interface element including a label for the first trading parameter.

4. The method of claim 1, wherein the first trading parameter comprises at least one of a last traded price, a last traded quantity, a total traded quantity, a total traded quantity at price, a volume at price, a price at open, and a price at close for a tradeable object.

5. The method of claim 4, wherein the second trading parameter comprises at least one of a volatility, a trend, a relative value, a range, and an alert related to the first trading parameter.

6. The method of claim 1, further comprising displaying a third trading parameter via the first user interface element.

7. The method of claim 1, further comprising displaying, via the first user interface element, a level line representing a historical indication with respect to the first trading parameter.

8. A system comprising:
a computing device configured to provide a graphical trading interface, the computing device to:
define a first user interface element to be displayed via the graphical trading interface;
identify a first trading parameter to be displayed via the first user interface element;
determine a second trading parameter to be displayed with the first trading parameter via the first user interface element, the second trading parameter to be display concurrently with but discernible from the first trading parameter via the first user interface element; and
display data relating to the first trading parameter and data relating to the second trading parameter via the first user interface element.

9. The system of claim 8, wherein data relating to the first trading parameter is displayed as alphanumeric data and wherein data relating to the second trading parameter is displayed via at least one of color, shading, and texture.

10. The system of claim 8, wherein the first user interface element is to display data relating to a value for the first trading parameter, and wherein the computing device is further to display a second user interface element including a label for the first trading parameter.

11. The system of claim 8, wherein the first trading parameter comprises at least one of a last traded price, a last traded quantity, a total traded quantity, a total traded quantity at price, a volume at price, a price at open, and a price at close for a tradeable object.

12. The system of claim 11, wherein the second trading parameter comprises at least one of a volatility, a trend, a relative value, a range, and an alert related to the first trading parameter.

13. The system of claim 8, wherein the computing device is to display a third trading parameter via the first user interface element.

14. The system of claim 8, wherein the computing device is to display, via the first user interface element, a level line representing a historical indication with respect to the first trading parameter.

15. A tangible computer-readable storage medium comprising instructions that, when executed, cause a computing device to at least:
define a first user interface element to be displayed via a graphical trading interface;
identify a first trading parameter to be displayed via the first user interface element;
determine a second trading parameter to be displayed with the first trading parameter via the first user interface element, the second trading parameter to be display concurrently with but discernible from the first trading parameter via the first user interface element; and
display data relating to the first trading parameter and data relating to the second trading parameter via the first user interface element.

16. The computer-readable storage medium of claim 15, wherein data relating to the first trading parameter is displayed as alphanumeric data and wherein data relating to the second trading parameter is displayed via at least one of color, shading, and texture.

17. The computer-readable storage medium of claim 15, wherein the first user interface element is to display data relating to a value for the first trading parameter, and wherein the computing device is further to display a second user interface element including a label for the first trading parameter.

18. The computer-readable storage medium of claim 15, wherein the first trading parameter comprises at least one of a last traded price, a last traded quantity, a total traded quantity, a total traded quantity at price, a volume at price, a price at open, and a price at close for a tradeable object.

19. The computer-readable storage medium of claim 18, wherein the second trading parameter comprises at least one of a volatility, a trend, a relative value, a range, and an alert related to the first trading parameter.

20. The computer-readable storage medium of claim 15, wherein the computing device is to display a third trading parameter via the first user interface element.

21. The computer-readable storage medium of claim 15, wherein the computing device is to display, via the first user interface element, a level line representing a historical indication with respect to the first trading parameter.
